(19) United States
(12) Patent Application Publication
(10) Pub. No.: US 2013/0306647 A1
(43) Pub. Date: Nov. 21, 2013

(54) ATTACHABLE UTENSIL FOR A FLEXIBLE POUCH CONTAINING EDIBLE MATERIAL

(71) Applicant: Aviruth Sachdev, Bangkok (TH)

(72) Inventor: Aviruth Sachdev, Bangkok (TH)

(21) Appl. No.: 13/474,565

(22) Filed: May 17, 2012

(51) Int. Cl. A47G 19/06; B23P 11/00

(52) U.S. Cl. 220/574.1; 215/228; 29/428

(57) ABSTRACT

The present invention relates to an attachable utensil that removably attaches to a flexible pouch containing edible material in order to facilitate convenient feeding from the pouch. The utensil contains a fitment end for attaching to a valve of the pouch, a neck portion that connects the fitment end to a serving end, and a serving end that receives the edible material and allows the user to eat or feed the edible material in a convenient and comfortable manner.

### FIELD OF THE INVENTION

The present invention relates to a utensil that attaches to the spout and valve of a flexible pouch containing edible material in order to facilitate convenient feeding from the pouch and more specifically to a removably attachable spoon for feeding infants or invalids.

### BACKGROUND OF THE INVENTION

The use of flexible pouches containing edible materials has become commonplace for food companies making products for infants and invalids. These pouches are known in the industry generally as bag-on-valve (BOV) containers. A typical pouch is made from opposing flexible foil and/or plastic sidewalls which are sealed to each other around their edges and may include a gusseted bottom wall sealed to the sidewalls allowing the pouch to have a stable base upon which the pouch can rest on a flat surface such as a table top. A polypropylene, or other similar material, valve and/or spout is itself sealed between the sealed edges of the sidewalls usually at the end of the pouch opposite the gusseted bottom wall. A user can then easily squeeze the sidewalls of the pouch to force dispensing of edible materials out of the valve.

Generally, the pouches are sold with a lid or cap screwed onto the valve to prevent the edible material from interacting with the environment or being tampered with prior to use. The use of the cap or lid is thus beneficial for these purposes, but typically results in the valve having a simple shape, such as a threaded cylinder. Because infants and invalids are generally spoon fed, the valves on pouches are inconvenient for feeding.

Various feeding devices or dispensing utensils are known in the art, for example: U.S. Patent Publication No. 2010/0147885 to Braxton et al. describes a food dispensing mouthpiece that may be configured to attach to a flexible pouch containing edible material; U.S. Patent Publication No. 2010/0186237 to Cunningham describes a fluidic utensil that affixes to containers in order dispense liquid; and U.S. Pat. No. 5,137,183 to Mikulec et al. describes a compressible feeding apparatus for dispensing edible or medicinal materials. Many of the utensil apparatuses included in these references are not suitable for the valves of the flexible pouches currently being used to dispense edible material. These references neither disclose a structure or functionality which ensures alignment of the utensil with the flexible pouch in a variable manner which facilitates feeding, nor do they disclose any type of an inverted, overlapping sealing connection facilitating communication between the opening in the valve of a flexible pouch and the channel of the feeding apparatus.

As a result, there is a need for a utensil which attaches to a flexible pouch that overcomes these disadvantages and dispenses the edible material in a manner that is more convenient to use.

### OBJECTS AND SUMMARY OF THE INVENTION

The first object of the present invention is to provide a more convenient means of dispensing edible material from flexible pouches, and more specifically, by providing a utensil to conveniently facilitate feeding from the pouches.

Another object of the present invention is to provide a utensil that can removably attach to a flexible pouch containing edible material such that the utensil can be attached to a flexible pouch for use, be removed for cleaning, and then reused with either the original pouch or a new flexible pouch.

A still further object of the present invention is to provide a utensil that allows feeding from flexible food pouches to be performed using one hand, which frees up the second hand to assist in holding an infant or invalid.

Another object of the present invention is to provide a utensil for adaption to a flexible food pouch that is transparent to allow for the user to easily see the amount and speed of the edible material that is flowing through the utensil. The transparency of the utensil would also facilitate the cleaning of the utensil after use by ensuring that all of the edible material was properly washed out.

A still further object of the present invention is to use a material for the attachable utensil that provides gumming or teething support, similar to that of a pacifier, such that an infant or invalid can safely chew on the attachable utensil.

The present invention relates to an attachable utensil comprising: a fitment end configured to removably attach the utensil to a flexible pouch containing edible material, wherein the fitment end includes an internal cavity for receiving a valve of the flexible pouch; a neck portion that connects the fitment end to a serving end, wherein the neck portion includes a channel for transporting the edible material that starts at a receiving opening in the fitment end and extends through the neck portion to a dispensing opening in the serving end; a concave portion in the serving end that facilitates eating the edible material; and wherein the receiving opening in the fitment end is defined by an inverted channel extending from the channel into the internal cavity of the fitment end to define a circumferential receiving slot for receiving and sealing with the end of the valve of the flexible pouch when engaged.

The present invention also relates to the attachable utensil described above further comprising a rib inside of the internal cavity in the fitment end for frictionally engaging with a base of the flexible pouch valve. The present invention further comprises a middle section in the internal cavity in the fitment end for receiving a threaded portion of the flexible pouch valve. The neck portion channel of the present invention may also be funnel-shaped. The external surface of the utensil may also have at least one protrusion attached to it to facilitate the attachment and removal of the utensil. The present invention may also be made from a soft polymeric material. The soft polymeric material of the present invention may be silicone.

The present invention further relates to a method of making an attachable utensil A method of making an attachable utensil to a bag-on-valve application, the method comprising the steps of: forming a fitment end configured to removably attach the utensil to a flexible pouch containing edible material, wherein the fitment end includes an internal cavity for receiving a valve of the flexible pouch; connecting a neck portion with the fitment end to a serving end, wherein the neck portion includes a channel for transporting the edible material that starts at a receiving opening in the fitment end and extends through the neck portion to a dispensing opening in the serving end; forming the serving end including a concave portion that facilitates eating the edible material; and wherein the receiving opening in the fitment end is defined by an inverted channel extending from the channel into the internal cavity of the fitment end to define a circumferential receiving slot for receiving and sealing with the end of the valve of the flexible pouch when engaged.

These and other features, advantages and improvements according to this invention will be better understood by reference to the following detailed description and accompanying drawings.

### BRIEF DESCRIPTION OF THE DRAWINGS

Several embodiments of the present invention will now be described by way of example only, with reference to the accompanying drawings in which:

FIG. 1 is a planar view of a first embodiment of the utensil of the present invention removably attached to a flexible pouch containing edible material;

FIG. 2 is a planar view of a flexible pouch valve attached to a flexible pouch containing edible material;

FIG. 3 is a bottom view of a first embodiment of the utensil of the present invention including the cross-sectional line C;

FIG. 4 is a cross-sectional view of the first embodiment along the line C as shown in FIG. 3;

FIG. 5A is a side view of a first embodiment of the utensil attached to the valve of a flexible pouch;

FIG. 5B is an exploded cross-sectional view of the fitment end of a first embodiment of the utensil of the present invention attached to the valve of a flexible pouch as indicated in FIG. 5A;

FIG. 6 is a planar view from the bottom of a first embodiment of the utensil of the present invention; and

FIG. 7 is a perspective view of a first embodiment of the utensil of the present invention.

### DETAILED DESCRIPTION OF THE PREFERRED EMBODIMENTS

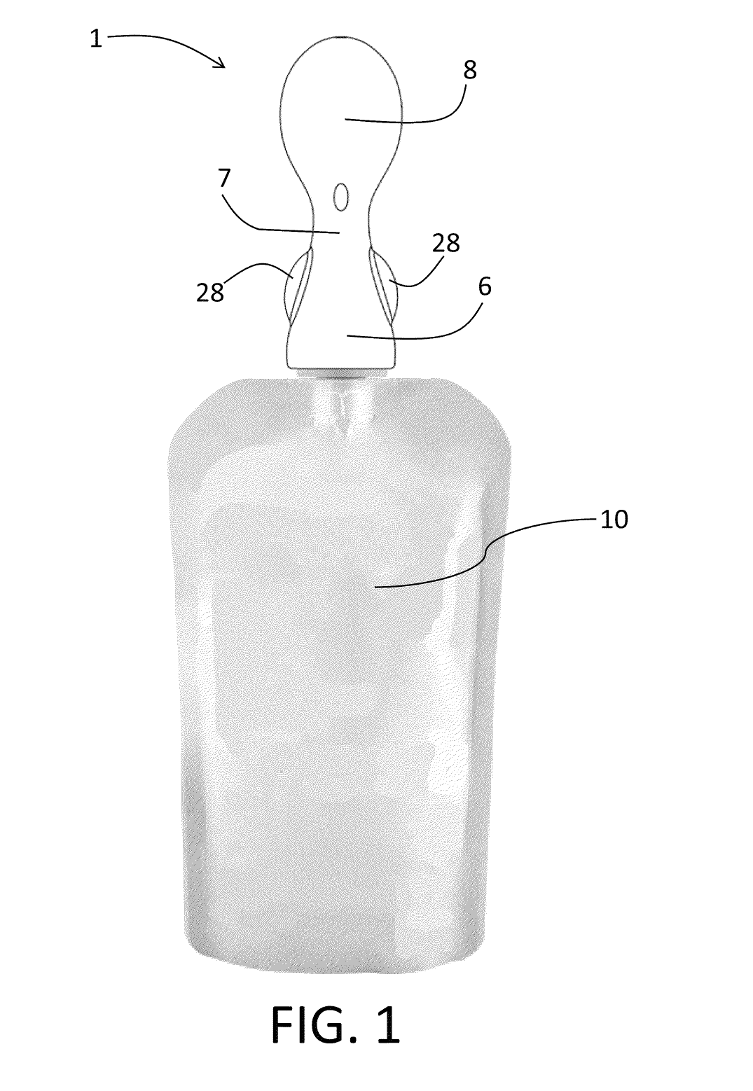

Turning initially to FIG. 1, the present invention relates to an attachable utensil 1 for removably engaging with a container, such as a flexible pouch 10 containing edible material, and methods related to making the same. Such a flexible pouch 10 is often referred to in the industry as a bag-on-valve (“BOV”) container where the flexible pouch is sealed by heat, pressure and adhesive materials to a rigid valve through which product can be introduced and dispensed from the flexible pouch 10. The attachable utensil 1, hereinafter referred to as the “utensil,” is provided as described above to conveniently facilitate the serving of edible material from a flexible food pouch 10 while providing other advantages as described herein. Although the utensil 1 will be shown and described as a spoon in use with flexible pouches 10 by way of example, the utensil 1 could be any type of utensil such as a fork, knife, spork, or any such similar food handling apparatus and be used with any container having a similar rigid valve or spout. Generally, the utensil 1 includes a fitment end 6 for releasably attaching with the valve 11 of the flexible pouch 10, a serving end 8 for serving food from the container to a user, and a neck portion 7 connecting the fitment end 6 and the serving end 8. A passage is formed through the neck portion 7 to deliver food from the flexible pouch 10 to the user.

Flexible pouches 10 containing edible material are well known in the art and are sold by various companies, such as Gerber® and Plum Organics™. Although most of these companies target their flexible food pouches toward infants and babies, these and other companies also make pouches for older children and adults. The edible material may have a fluid or semi-liquid consistency, where the term “semi-liquid” may include liquids and materials capable of flowing like a fluid that are neither fully solid nor fully liquid (e.g., ground or pureed vegetables or fruits, etc.). In various embodiments, the edible material may include, for example, infant food, medicine, sports related food, soft ice cream, etc.; although, it is understood that the above are merely a few illustrative examples to which the disclosed subject matter is not limited. The utensil 1 is generally suited for use with infants, babies, toddlers, and invalids to help facilitate either feeding or eating from the pouch without the assistance of other utensils.

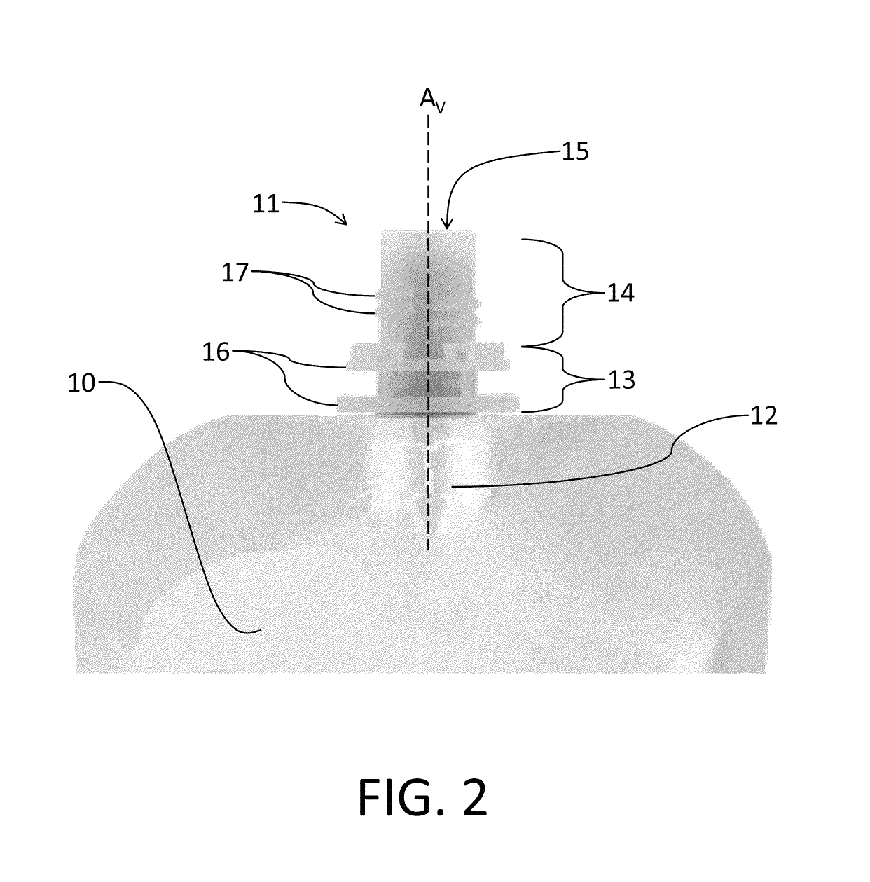

The flexible pouches 10 are typically airtight except for one opening, generally a spout or valve 11, which allows the pouch to be filled with the edible material and allows the end user to dispense the edible material. Valves used on these flexible pouches 10 may generally be shaped as shown in FIG. 2 which displays the valve 11 in the top of the flexible pouch 10 and the cap (not shown) already removed from the valve 11. The valve 11 has a lowermost sealing portion 12 which is heat, pressure or adhesively sealed between the outer edges of the pouch. The portion of the valve 11 visible above the sealed edges of the flexible pouch 10 has a base portion 13 and a neck portion 14 that defines a valve opening 15 which facilitates receiving and dispensing edible material from the pouch.

The base 13 of the valve 11 generally has at least one external flange 16. The neck 14 of the valve 11 generally has threads 17 to allow for the cap to be removably twisted onto the valve 11. The cap is removed before the end user dispenses the edible material from the pouch 10, but generally can be replaced to store the pouch 10 for later use. The cap also needs to be removed before using the utensil 1. The pouch 10 dispenses edible material, either with or without the utensil, when the user squeezes or applies pressure to the pouch 10.

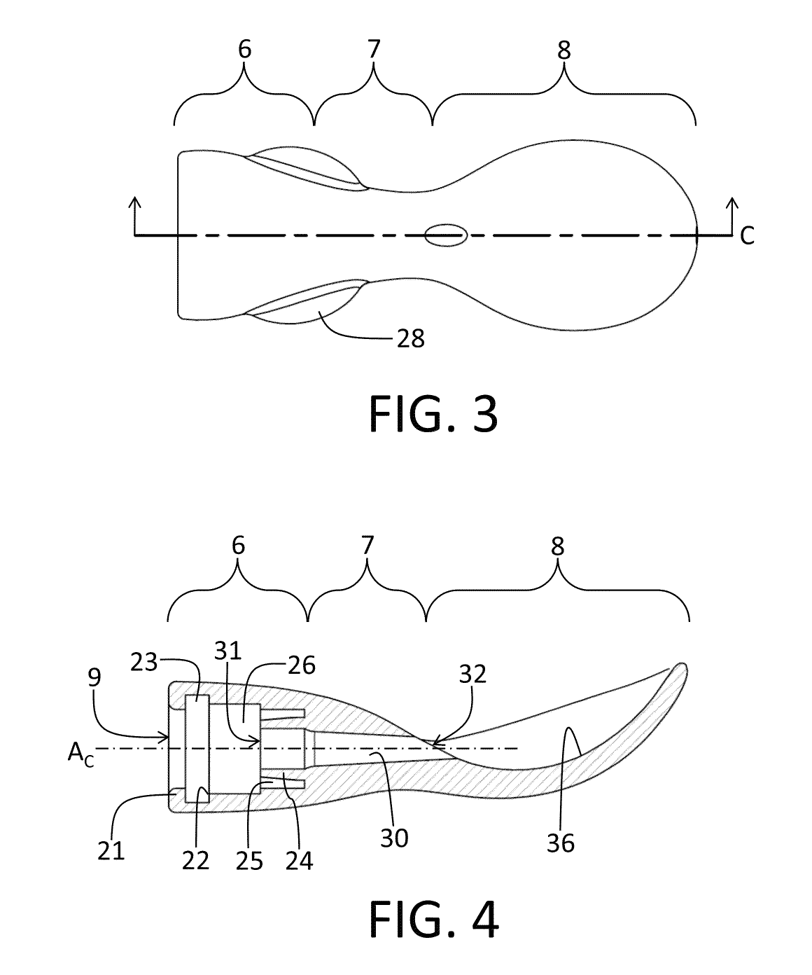

The three sections of the utensil 1—the fitment end 6, the neck portion 7, and the serving end 8—will now be described in greater detail as shown in FIG. 3. The fitment end 6 of the utensil 1 attaches to the valve 11 of the flexible pouch 10. The neck portion 7 of the utensil 1 contains a channel 30 that allows the fitment end 6 to communicate with the serving end 8. The serving end 8 allows the user to conveniently serve or consume the edible material that is dispensed from the channel 30 in the neck portion 7. In order to understand the inner structure of the utensil, FIG. 4 provides a cross sectional view of the utensil 1 along the line C shown in FIG. 3.

Since the utensil 1 is made from a soft polymeric material, such as silicone, the majority, if not the entirety, of the utensil 1 is flexible. As can be seen in FIGS. 4 & 5, the current embodiment of the utensil 1 is ribbed and corrugated to slidably engage with the valve 11 of the flexible pouch 10 by expanding the internal cavity 9 of the fitment end 6 over the valve 11 in order to frictionally secure the fitment end 6 of the utensil onto the valve 11. While there are some similar utensils which utilize screw threads to engage a utensil with the screw threads on the valve, the flexibility of the described utensil 1 of this embodiment of the present invention is important because it permits the utensil 1 to be removably attached onto the valve, i.e. with minimal to no relative rotation between the utensil or pouch in this first embodiment. The utensil 1 may also be attached and aligned in any orientation with the pouch 10 desired by the user; however, it is understood that the embodiment shown is one illustrative example to which the disclosed subject matter is not limited.

The fitment end 6 of the utensil 1 has an internal rib 21 that facilitates the connection of the utensil 1 to the pouch valve 11. The utensil 1 attaches to the valve 11 by sliding over the neck portion 14 of the valve 11 to the point that the internal rib 21 of the utensil 1 expands over the top external flange 16 of the base portion 13 of the valve. After the internal rib 21 fully passes over and beyond the external flange 16 as the utensil 1 slides toward the pouch 10, the rib 21 contracts back to its normal state to provide a radially directed frictional engagement with the external flange 16 preventing the utensil 1 from being removed from the pouch valve 11. In other various embodiments, the utensil 1 may have differently configured fitment ends 6 that allow for the utensil 1 to, for example, snap onto a valve that is configured to mate with the utensil 1.

The fitment end 6 of the utensil 1 may also contain an internal ledge 22 that helps align the utensil 1 relative to the valve 11 by resting on the top of the external flange 16 and providing an axially directed frictional engagement as well as the radially directed engagement. Thus, the inclusion of an internal ledge 22 creates an engagement space 23 between the ledge 22 and the internal rib 21 for the valve's external flange 16 to exist when the utensil 1 is engaged with the pouch valve 11. The flexible material of the utensil 1 uses both radially and axially directed forces to form a tight seal. Frictional engagement is not possible with a hard material type utensil which uses merely the axial forces generated by the engagement of screw threads to secure the utensil to the valve 11.

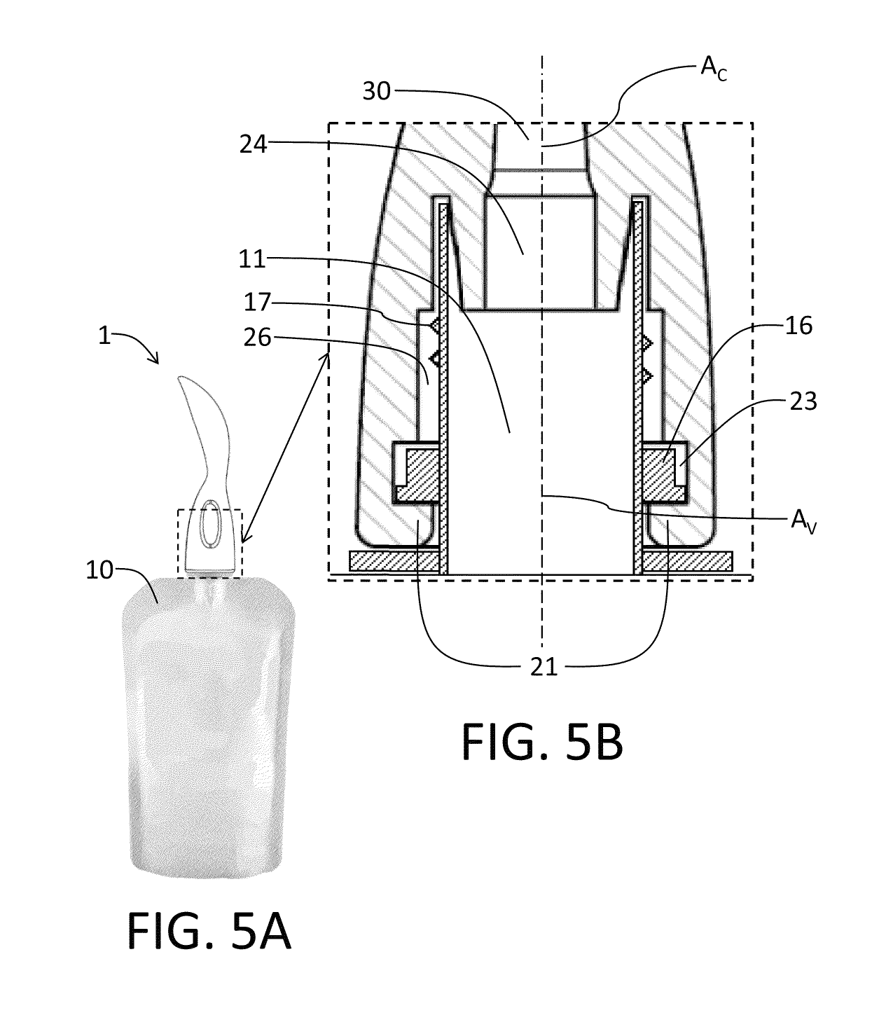

The characteristics of the material of the utensil are such that when the utensil 1 is engaged with the valve 11, a substantial seal is created so that the edible material will only travel from the valve opening 15, to and through the channel 30, and ultimately out to the serving end 8 as described below. To ensure that the edible material does not enter the cavity in the fitment end, but only travels into the channel 30 of utensil 1, the utensil may have an inverted channel portion 24 extending from the channel 30 in the neck portion 7 into the internal cavity 9 in the fitment end 6 of the utensil 1. This inverted channel portion 24 enters the opening 15 in the top of the valve and extends axially down into the valve and below the opening 15 when engaged as shown in FIGS. 5A and 5B. When the inverted channel portion 24 enters the valve opening 15, there is an overlapping connection between fitment end 6 of the utensil 1 and the valve 11 as shown in FIG. 5B. The inverted channel portion 24 is an important aspect of the present embodiment which thereby assists with the engagement of the utensil 1 to the valve 11. The inverted channel portion also creates a sealed connection between the channel 30 of the utensil and the interior of the neck portion 14 of the valve 11.

The inverted channel portion 24 defines an internal slot 25 that the upper portion of the valve neck 14 fits into when the inverted channel portion 24 enters the valve opening 15. This provides consistent alignment each time between the valve 11 and the utensil 1 where the end of the valve 11 abuts the bottom of the internal slot 25 to ensure that the utensil is axially aligned with the valve 11. This internal slot 25 further facilitates the sliding, axial engagement of the utensil 1 on the valve 11. The internal slot 25 also assists with alignment during attachment and can contribute to the creation of the seal between the valve opening 15 and the inverted channel portion 24.

Another advantage of the inverted channel portion 24 is that it helps to align the utensil 1 when slidingly engaging the fitment end 6 to the valve 11, thereby providing an axially aligned fit every time the utensil 1 is attached to the pouch valve 11. The valve 11 is defined about an axis A_{V}, and the channel 30 of the utensil 1 is defined about another axis A_{C}, and by axially aligned is meant that the axis A_{V} and A_{C} are essentially co-axial as shown in FIG. 5B with axis Av shown in a dashed line and axis A_{C} shown in a dash-dot line. Without the inverted channel portion 24, the utensil may not fully axially align with the valve 11 or create a substantial seal, which would allow edible material to enter the remainder of the fitment end 6, and potentially leak out, during use. Other attachment methods, such as screwing the utensil 1 onto the threaded valve 11, are not as advantageous because they do not ensure a sealed fit or fully align the channel 30 in the neck portion 7 with the opening 15 in the valve 11, which would result in edible material entering the internal cavity 9 of the fitment end 6.

Further, using other attachment methods, such as a threaded or screw-on fit, typically results in the utensil 1 having a final rotational position which limits the orientation of the utensil 1 relative to the pouch 10 to one position. This would add to the inconvenience of using the utensil 1 to feed the edible material within the pouch 10 to infants or invalids, especially when only one hand is free to operate the pouch 10. However, because the utensil slidingly engages as described above, the utensil 1 can be rotationally oriented to any rotational position relative to the pouch that the user desires after the fitment end 6 of the utensil 1 is attached to the valve 11. Thus, the most comfortable or convenient eating or feeding orientation can be chosen by merely twisting the utensil 1 relative to the pouch 10 overcoming the above noted axial and radial forces between the utensil 1 and the valve 11 and aligning the utensil in a desired orientation before dispensing the edible material. For example, the utensil can be oriented as shown in FIG. 1 or it can be easily twisted 90 degrees to the orientation shown in FIG. 5A or any other rotational orientation that the user finds to be the most comfortable or convenient to use.

The inverted channel portion 24 provides the additional benefit of preventing edible material from entering the receiving cavity in the fitment end 6 of the utensil 1 when the utensil 1 is removed from the valve 11. When desired, the utensil 1 can be removed by the user by pulling it away from or disengaging it from the valve 11. If the utensil 1 is removed after use, some edible material is typically left in the channel 30 of the utensil 1. However, the inverted channel portion 24 essentially extends the operating length of the channel 30, such that when the utensil 1 is removed after use, the remaining edible material separates from the edible material in the valve 11 (based on the typical consistency of the edible material in these pouches) and remains within the channel 30 and inverted channel portion 24. This feature assists with the cleaning of the utensil after use.

As shown in FIGS. 4 & 5, the internal cavity 9 of the fitment end 6 also contains a middle section 26 that allows for the threads 17 on the valve neck 14 to fit within the utensil 1. The middle section 26 is generally circular to match the shape of the valve 11; however, the section 26 could take any shape that would house the threaded portion of the valve neck 14. Thus, the internal cavity 9 of the fitment end 6 of the utensil 1 is shaped to substantially mate with the valve 11 of a flexible pouch 10 containing edible material as shown in FIG. 5B.

The fitment end 6 may additionally have an external feature to assist in the attachment and removal of the utensil 1. As can be seen in FIGS. 1 & 3, the present embodiment of the utensil 1 is shown having opposing external protrusions 28 or wings that add to the aesthetics of the utensil 1 and also help the user attach and remove the fitment end 6 to the valve 1. This external feature could also be in the shape of ribs, bumps, slits, or other various combinations of protrusions and depressions on the outside of the fitment end 6 and/or neck portion 7 of the utensil 1.

The neck portion 7 of the utensil 1 connects the fitment end 6 to the serving end 8. The channel 30 in the neck portion 7 of the utensil extends from the receiving opening 31 in the fitment end 6 to the dispensing opening 32 in the serving end 8 and may have any shape, size, or length. The general purpose of the channel 30 is to provide communication between the fitment end 6 and the serving end 8. When the utensil 1 is attached or engaged to the valve 11 and the user squeezes the edible material from the pouch 10 out the valve opening 15, the edible material will eventually travel through the channel 30 and out of the dispensing opening 32 into the serving end 8 of the utensil to allow for the user to eat or feed the edible material.

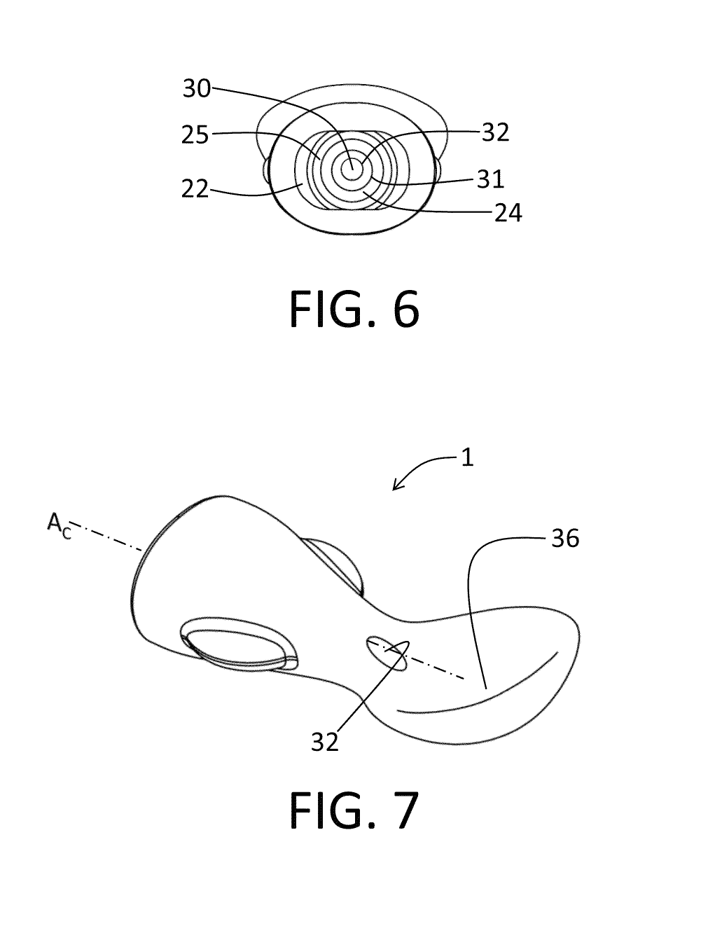

The receiving opening 31, dispensing opening 32, and channel 30 therebetween may have various shapes and sizes. In the present embodiment of the utensil, as shown in FIGS. 6 & 7, the receiving opening 31 is circular in shape and has a larger diameter relative to the dispensing opening 32, which is also circular in shape. The channel 30 forms a funnel from the receiving opening 31 to the dispensing opening 32 in order to guide the edible material out of the smaller sized dispensing opening 32 as the user squeezes the pouch 10. This funnel-shaped channel 30 requires more force to squeeze the edible material out of the pouch and ultimately to the serving end 8, which helps to provide a more controllable dispensing flow rate.

The serving end 8 of the utensil 1 as shown in FIG. 7 has a concave portion 36; however, it is understood that the embodiment shown is simply one illustrative example to which the disclosed subject matter is not limited. In other various embodiments, the utensil 1 may have a differently shaped and sized serving end 8. The concave portion 36 of the serving end 8 of the present embodiment is similar to a spoon and receives the edible material after it is squeezed from the pouch 10 and out of the dispensing opening 32 as described above. The concave portion 36 is configured to hold the dispensed edible material to facilitate eating or feeding from the utensil 1.

The use of soft polymeric materials, such as silicone, for the utensil 1 ensures that the serving end 8 is soft and flexible. Because of these properties of the material, the utensil 1 is safe to chew on. For invalids, this is preferable because the utensil 1 would not cause any damage to their teeth or jaws if the serving end was chewed on during use. For infants, this is preferable because it allows the utensil 1 to double as a gumming device. Accordingly, the serving end 8 of the utensil 1 may be configured to have additional textures for gumming or chewing purposes.

The soft polymeric material used for the utensil 1 also provides cost and manufacturing benefits. The utensil 1 is typically molded into a single piece and because it is made from, e.g., silicone, no secondary manufacturing processes are required to produce the end product. This is a further advantage over hard plastic attachment devices, because hard plastic devices typically require multiple molds, multiple parts, or secondary processes to remove the imperfections before achieving the end product. Silicone is also a more cost-effective and durable material. This all results in cost savings and other benefits from a production standpoint.

Using a transparent material for the utensil 1, such as silicone, not only adds to the aesthetics of the overall device, but also allows the user to see the food travel through the channel 30 in the neck portion 7. Being able to see into the utensil 1 also makes cleaning easier by allowing any edible material leftover within the utensil 1 after use to be seen. The use of silicone provides additional benefits, which are particularly important when using the utensil 1 with infants. These benefits include being able to boil the utensil for sterility purposes, being a material that is recognized as safe for infant use, and the advantages derived from using a soft and flexible material, such as the gumming and manufacturing benefits described above.

The invention has been described in detail with particular reference to certain preferred embodiments thereof, but it will be understood that variations and modifications can be effected within the spirit and scope of the invention.

1. An attachable utensil, comprising:
a fitment end configured to removably attach the utensil to a flexible pouch containing edible material, wherein the fitment end includes an internal cavity for receiving a valve of the flexible pouch, the internal cavity having a middle section and an engagement space;
a neck portion that connects the fitment end to a serving end, wherein the neck portion includes a channel for transporting the edible material that starts at a receiving opening in the fitment end and extends through the neck portion to a dispensing opening in the serving end;
a concave portion in the serving end that facilitates eating the edible material; and
wherein an external flange of the valve is frictionally engaged within the engagement space of the internal cavity and the receiving opening in the fitment end is defined by an inverted channel extending from the channel into the middle section of the internal cavity of the fitment end to define a circumferential receiving slot for receiving and sealing with the end of the valve of the flexible when engaged.

2. The attachable utensil as set forth in claim 1, further comprising a rib within the engagement space of the internal cavity in the fitment end for frictionally engaging with the external flange of the flexible pouch valve.

3. The attachable utensil as set forth in claim 2, wherein the middle section in the internal cavity in the fitment end receives a threaded portion of the flexible pouch valve.

4. The attachable utensil as set forth in claim 3, wherein the neck portion channel is funnel-shaped.

5. The attachable utensil as set forth in claim 4, further comprising at least one protrusion attached to an external surface of the utensil to facilitate the attachment and removal of the utensil.

6. The attachable utensil as set forth in claim 1, wherein the utensil is made from a soft polymeric material.

7. The attachable utensil as set forth in claim 6, wherein the soft polymeric material is silicone.

8. A method of making a utensil for attachment to a flexible pouch, comprising the steps of:
forming a fitment end configured to removably attach the utensil to a flexible pouch containing edible material, wherein the fitment end includes an internal cavity having a middle section and an engagement space for receiving a valve of the flexible pouch;
forming a neck portion and connecting the neck portion to the fitment end and to a serving end, wherein the neck portion includes a channel for transporting the edible material that starts at a receiving opening in the fitment end and extends through the neck portion to a dispensing opening in the serving end;
forming the serving end including a concave portion that facilitates eating the edible material;
frictionally engaging an external flange of the valve within the engagement space of the internal cavity; and
wherein the receiving opening in the fitment end is defined by an inverted channel extending from the channel into the middle section of the internal cavity of the fitment end to define a circumferential receiving slot for receiving and sealing with the end of the valve of the flexible pouch when engaged.

9. The method of making a utensil for attachment to a flexible pouch as set forth in claim 8, further comprising the step of forming a rib within the engagement space of the internal cavity in the fitment end for frictionally engaging with the external flange of the flexible pouch valve.

10. The method of making a utensil for attachment to a flexible pouch as set forth in claim 9, further comprising the step of receiving a threaded portion of the flexible pouch valve within the middle section of the internal cavity.

11. The method of making a utensil for attachment to a flexible pouch as set forth in claim 10, further comprising the step of forming the neck portion channel in the shape of a funnel

12. The method of making a utensil for attachment to a flexible pouch as set forth in claim 11, further comprising the step of forming at least one protrusion on an external surface of the utensil to facilitate the attachment and removal of the utensil.

13. The method of making a utensil for attachment to a flexible pouch as set forth in claim 8, further comprising the step of forming the utensil from a soft polymeric material.

14. The method of making a utensil for attachment to a flexible pouch as set forth in claim 13, wherein the soft polymeric material is silicone.
